(19) United States
(12) Patent Application Publication
(10) Pub. No.: US 2010/0247786 A1
(43) Pub. Date: Sep. 30, 2010

(54) NEW POLYMERS BY EMULSION POLYMERIZATION

(75) Inventors: Marc Schroeder, Canton, MI (US); Konrad Roschmann, Ludwigshafen-Edigheim (DE); Hans Renz, Meckenheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASE SE, Ludwigshafen (DE)

(21) Appl. No.: 12/741,609

(22) PCT Filed: Nov. 18, 2008
(86) PCT No.: PCT/EP08/65712

§ 371 Date: May 6, 2010

(30) Foreign Application Priority Data
Nov. 21, 2007 (EP) 07121177.5

(51) Int. Cl. C08F 236/10; B05D 3/02

(52) U.S. Cl. 427/388.1; 526/303.1; 526/320

(57) ABSTRACT

The present invention relates to new emulsion polymers, to processes for preparing them, and to their use in coating material for the purpose of improving the water resistance.

The present invention relates to new emulsion polymers, to processes for preparing them, and to their use in coating materials for the purpose of improving the water resistance.

The implementation of free-radically initiated emulsion polymerizations of ethylenically unsaturated monomers in an aqueous medium has been described on numerous previous occasions and is therefore adequately known to the skilled worker. Free-radically induced aqueous emulsion polymerization reactions typically take place by the ethylenically unsaturated monomers being dispersed, using dispersing assistants, in the aqueous medium in the form of monomer droplets and being polymerized by means of a free-radical polymerization initiator. The present process differs from this procedure in particular in the specific way in which monomer is supplied.

WO 2006/136575 discloses the preparation, for pressure-sensitive adhesives, of emulsion polymers which comprise carboxyl-containing monomers in copolymerized form and for whose preparation the carboxyl-containing monomers are metered in more quickly than the other monomers. This preparation process gives pressure-sensitive adhesives whose adhesion is improved.

The international application WO 2007/125027 discloses metering compounds containing at least two ethylenically unsaturated groups into the reaction mixture more slowly than the other monomers. The polymers obtainable in this way feature reduced formation of coagulum.

Polymer dispersions are polymer particles in dispersion in an aqueous medium. For the purpose of stabilizing the colloidal state, the polymer particles carry hydrophilic groups comprising hydrophilic monomers, or emulsifiers on the surface. As a result, polymer films obtained from polymer dispersions display properties of hydrophilicity to a certain degree. For application in coating materials, more particularly for protecting metallic surfaces from corrosion, however, the polymer film is intended to raise the barrier with respect to water. The polymer films ought therefore to have a low level of hydrophilicity or, respectively, very high hydrophobicity. Particularly suitable for that purpose are styrene-butadiene copolymers, whose hydrophobicity is generally fairly high.

It was an object of the present invention to increase the hydrophobicity of emulsion polymers.

This object has been achieved by means of an emulsion polymerization process for preparing polymers comprising as synthesis components in copolymerized form
(A) at least one vinylaromatic compound,
(B) at least one compound having two conjugated ethylenically unsaturated double bonds,
(C) at least one ethylenically unsaturated compound selected from the group consisting of compounds having at least one amide function and hydroxyalkyl (meth)acrylates,
(D) optionally at least one compound, other than the compounds (A) and (C), having an ethylenically unsaturated double bond, and
(E) optionally at least one compound, other than compounds (B), having at least two ethylenically unsaturated double bonds,
   at least a portion of the monomers being metered into the reaction mixture during the polymerization over a certain time period (metering period),
   which involves metering less than half the total amount of the monomer (C) into the reaction mixture in the first half of the metering period.

The present invention further provides the polymers obtainable by the process of the invention.

The emulsion polymers obtainable by the process of the invention exhibit an increased hydrophobicity, which is manifested, for example, in reduced water absorption. At the same time, however, the polymer dispersions obtained are sufficiently stable. As a measure of this stability it is possible to take the fact that storage of the polymer dispersions of the invention is accompanied by the formation of a smaller fraction of coagulum than in the case of polymer dispersions which have the same composition but have been obtained by conventional metering of the monomer (C).

The monomer (A) is at least one, one to three for example, preferably one to two, more preferably precisely one vinylaromatic compound. This term refers to compounds which comprise precisely one ethylenically unsaturated double bond and an aromatic ring system. Preferably the ethylenically unsaturated double bond and the aromatic ring system are conjugated.

Examples of such monomers are styrene, α-methylstyrene, o-chlorostyrene, 2-, 3- or 4-vinyltoluene, preferably styrene and α-methylstyrene, and more preferably styrene.

The monomers (B) are at least one, one to three for example, preferably one to two, more preferably precisely one compound which comprises two ethylenically unsaturated double bonds which are conjugated with one another, preferably exclusively precisely one conjugated pair of ethylenically unsaturated double bonds.

Examples of such monomers are conjugated dienes containing preferably 4 to 8 carbon atoms, such as 1,3-butadiene, 1,3-pentadiene, isoprene, chloroprene, cyclopentadiene, and cyclohexadiene, preferably 1,3-butadiene and isoprene, more preferably 1,3-butadiene.

The compounds (C) are at least one, one to three for example, preferably one to two, more preferably precisely one ethylenically unsaturated compound having at least one, one to two for example, preferably precisely one amide function and one to two, preferably precisely one, ethylenically unsaturated double bond, selected from the group consisting of

(C1) compounds having at least one amide function and
(C2) hydroxyalkyl (meth)acrylates.

The compounds (C1) are compounds having at least one, one to three for example, preferably one to two, and more preferably precisely one amide function.

By an amide function are meant here carboxamide functions (—(CO)—N<) which may be unsubstituted, singly substituted or doubly substituted on the amidic nitrogen atom, preferably unsubstituted. In the preferred first case the function is —(CO)—NH₂.

With particular preference the monomers (C1) are acrylamides or methacrylamides (C1a).

Examples of monomers (C1a) are N-methylacrylamide, N-methylmethacrylamide, N-ethylacrylamide, N-ethylmethacrylamide, N-n-propylacrylamide, N-n-propyl-methacrylamide, N-isopropylacrylamide, N-isopropylmethacrylamide, N,N-dimethyl-acrylamide, N,N-dimethylmethacrylamide, diacetoneacrylamide, and N,N′-methylene-bisacrylamide.

The monomer in question is preferably acrylamide or methacrylamide and more preferably acrylamide.

Further compounds (C1) are N-vinylcarboxamides (C1b), in which case the parent carboxamide may be aliphatic or cyclic and contains preferably not more than 6, more preferably not more than 4, very preferably not more than 2, and more particularly 1 carbon atom.

Preferred compounds (C1b) are N-vinylformamide, N-vinylacetamide, N-vinyl-pyrrolidone, and N-vinylcaprolactam.

The hydroxyalkyl (meth)acrylates (C2) are simple acrylic or methacrylic esters of aliphatic diols, the diols containing preferably not more than 6, more preferably not more than 4, very preferably not more than 3, and more particularly 2 carbon atoms. The diols are preferably 1,ω-diols.

Preferred compounds (C2) are therefore 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 4-hydroxybutyl acrylate, and 4-hydroxybutyl methacrylate. Particular preference is given to 2-hydroxyethyl acrylate, 2-hydroxyethyl methacrylate, 2-hydroxypropyl acrylate and 2-hydroxypropyl methacrylate, very particular preference to 2-hydroxyethyl acrylate and 2-hydroxyethyl methacrylate.

Of the compounds (C), preference is given to (C1a) and (C2), particular preference to the compounds (C1a).

The optional compounds (D) are at least one compound other than the above-described compounds (A) and (C) having precisely one ethylenically unsaturated double bond.

The compounds (D) are preferably selected from the group consisting of (D1) esters of vinyl alcohol and monocarboxylic acids containing 1 to 18 C atoms, such as vinyl acetate, vinyl propionate, vinyl n-butyrate, vinyl laurate, and vinyl stearate, (D2) esters of α,β-monoethylenically unsaturated monocarboxylic and dicarboxylic acids containing preferably 3 to 6 C atoms, such as, for example, acrylic acid, methacrylic acid, maleic acid, fumaric acid, and itaconic acid, preferably acrylic acid and methacrylic acid, more preferably acrylic acid, with alkanols containing generally 1 to 12, preferably 1 to 8, and more particularly 1 to 4 C atoms, such as, preferably, methyl, ethyl, n-butyl, isobutyl, and 2-ethylhexyl acrylate and methacrylate, dimethyl maleate or di-n-butyl maleate, more preferably methyl, ethyl, n-butyl or 2-ethylhexyl ester,

(D3) nitriles of α,β-monoethylenically unsaturated carboxylic acids, such as acrylonitrile or methacrylonitrile, and
(D4) α,β-monoethylenically unsaturated monobasic and dibasic acids, examples being acrylic acid, methacrylic acid, itaconic acid, vinylphosphonic acid, vinylsulfonic acid, maleic acid, and maleic anhydride.

The optional monomers (E) are at least one other compound having at least two, 2 to 6 for example, preferably 2 to 4, more preferably 2 to 3, and very preferably two ethylenically unsaturated double bonds.

Examples of such monomers are monomers containing at least two vinyl radicals, monomers containing at least two vinylidene radicals, and monomers containing at least two alkenyl radicals. Particularly advantageous in this context are the diesters of dihydric alcohols with α,β-monoethylenically unsaturated monocarboxylic acids, among which acrylic acid and methacrylic acid are preferred. Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate, and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also o-, m-, and/or p-divinylbenzene, vinyl methacrylate, vinyl acrylate, allyl methacrylate, allyl acrylate, diallyl maleate, diallyl fumarate, diallyl phthalate, methylenebisacrylamide, cyclo-pentadienyl acrylate, triallyl cyanurate or triallyl isocyanurate.

It will be appreciated that mixtures of the aforementioned monomers (E) can also be used.

Advantageously use is made of o-, m- or p-divinylbenzene, 1,4-butylene glycol diacrylate, vinyl acrylate, vinyl methacrylate, allyl acrylate and/or allyl methacrylate as monomers (E).

The composition of the emulsion polymers of the invention is generally as follows:

(A) 40% to 80%, preferably 50% to 75% by weight,
(B) 20% to 60% by weight, preferably 25% to 50% by weight,
(C) 0.1% to 10% by weight, preferably 0.2% to 5%, and more preferably 0.3% to 2% by weight,
(D) 0% to 30% by weight, preferably 0.1% to 15%, and more preferably 0.5% to 5% by weight,
(E) 0% to 5% by weight, preferably 0% to 2%, and more preferably 0% by weight, with the proviso that the sum is always 100% by weight.

A feature of the invention is that monomers and also, if appropriate, polymerization regulators are added at least partly during the polymerization, and the process, therefore, is a feed process.

A portion of the monomers can if desired be included in the initial charge in the polymerization vessel at the beginning of the polymerization; the remaining monomers, or all of the monomers if no monomers are included in the initial charge, are added in the course of the polymerization in the case of the feed process.

The regulator as well (see below) can be included in part in the initial charge, added wholly or partly during the polymerization or added toward the end of the polymerization.

The monomers are added at least in part continuously during the polymerization. In part, monomers may also be included in the initial charge in the polymerization vessel before the polymerization is commenced.

It is preferred to include not more than 30% by weight of the total amount of the monomers, more preferably not more than 20% by weight, very preferably not more than 10% by weight of the monomers in the initial charge in the polymerization vessel. The remaining monomers, i.e., preferably at least 70%, more preferably at least 80%, very preferably at least 90% by weight, are added continuously during the polymerization. In one particular embodiment no monomers are included in the initial charge; in other words, the entirety of the monomers is run in during the polymerization.

The temperature of the polymerization mixture during the polymerization and, correspondingly, during the addition of the monomers is preferably at least 50° C., more preferably at least 70° C.

The addition of the monomers to the polymerization vessel (metering period) takes place preferably over a time period of at least two hours, more preferably at least 3 hours.

Other considerations applying to the implementation of the emulsion polymerization are as follows.

The emulsion polymerization takes place in general at 30 to 130, preferably 50 to 95° C. The polymerization medium may be composed either of water alone or else as mixtures of water and water-miscible liquids such as methanol. Preferably just water is used. The feed process can be carried out in a staged or gradient procedure. Preference is given to the feed process wherein a part of the polymerization batch is included in the initial charge and heated to the polymerization temperature and its polymerization is commenced, and then the remainder of the polymerization batch is supplied to the polymerization zone while the polymerization is maintained, the supply taking place continuously, in stages or subject to a concentration gradient and taking place typically by way of two or more spatially separate feeds, of which one or more comprise the monomers in pure form or in emulsified form. For the polymerization it is also possible to include a polymer seed in the initial charge for the purpose, for example, of setting the particle size more effectively.

The manner in which the initiator is added to the polymerization vessel in the course of the free-radical aqueous emulsion polymerization is known to a person of ordinary skill in the art. Alternatively it may be included in its entirety in the polymerization vessel or else used continuously or in stages, in accordance with the rate at which it is consumed, in the course of the free-radical aqueous emulsion polymerization. In each case this will depend on the chemical nature of the initiator system and also on the polymerization temperature. It is preferred to include part in the initial charge and to supply the remainder to the polymerization zone at the rate at which it is consumed.

In order to remove residual monomers, initiator is typically also added after the end of the emulsion polymerization proper, i.e., after a monomer conversion of at least 95%.

The individual components can be added to the reactor, in the case of the feed process, from above, in the side, or from below, through the reactor base.

The emulsion polymerization produces aqueous dispersions of the polymer in general with solids contents of 15% to 75%, preferably of 40% to 60%, by weight.

The polymer prepared in this way is used preferably in the form of its aqueous dispersion.

The glass transition temperature of the polymer is preferably −60° to +100° C., more preferably −20- to +60° C., and very preferably 0 to 50° C.

The glass transition temperature can be determined by typical methods such as differential thermoanalysis or differential scanning calorimetry (see, e.g., ASTM 3418/82, midpoint temperature).

The present process of the invention uses water, preferably drinking-grade water and more preferably deionized water, whose total amount is such that it is 30% to 90% and advantageously 50% to 80% by weight, based in each case on the aqueous copolymer dispersion obtainable through the process of the invention.

In accordance with the invention it is possible to include, if appropriate, a portion or the total amount of water in the initial charge to the polymerization vessel. It is also possible, however, to meter in the total amount or, if appropriate, the remainder of water together with the monomers, in particular in the form of an aqueous monomer emulsion. With advantage a small portion of water is included in the initial charge to the polymerization vessel and a larger portion of water is metered in as an aqueous monomer emulsion under polymerization conditions.

In the context of the process of the invention use is made also of dispersants, which keep not only the monomer droplets but also the resultant copolymer particles in dispersion in the aqueous phase and thus ensure the stability of the aqueous copolymer dispersion produced. Suitable such dispersants include not only the protective colloids, which are typically used for implementing free-radical aqueous emulsion polymerizations, but also emulsifiers.

Examples of suitable protective colloids are polyvinyl alcohols, cellulose derivatives or vinylpyrrolidone copolymers. An exhaustive description of further suitable protective colloids is found in Houben-Weyl, Methoden der organischen Chemie, volume XIV/1, Makromolekulare Stoffe [Macromolecular compounds], pages 411 to 420, Georg-Thieme-Verlag, Stuttgart, 1961.

It will be appreciated that mixtures of emulsifiers and/or protective colloids can be used as well. Dispersants used frequently comprise exclusively emulsifiers, whose relative molecular weights, unlike those of the protective colloids, are typically below 1000 g/mol. They may be anionic, cationic or nonionic in nature. Where mixtures of surface-active substances are used, the individual components must of course be compatible with one another, something which in case of doubt can be ascertained by means of a few preliminary tests. Generally speaking, anionic emulsifiers are compatible with one another and with nonionic emulsifiers. The same is true of cationic emulsifiers, whereas anionic and cationic emulsifiers are usually not compatible with one another.

Customary emulsifiers are, for example, ethoxylated mono-, di-, and tri-alkylphenols (EO degree: 3 to 50, alkyl radical: C₄ to C₁₂), ethoxylated fatty alcohols (EO degree: 3 to 50; alkyl radical: C₈ to C₃₆), and alkali metal salts and ammonium salts of alkyl sulfates (alkyl radical: C₈ to C₁₂), of sulfuric monoesters with ethoxylated alkanols (EO degree: 4 to 30, alkyl radical: C₁₂ to C₁₈), and ethoxylated alkylphenols (EO degree: 3 to 50, alkyl radical: C₄ to C₁₂), of alkylsulfonic acids (alkyl radical: C₁₂ to C₁₈), and of alkylarylsulfonic acids (alkyl radical: C₉ to C₁₈). Further suitable emulsifiers are found in Houben-Weyl, Methoden der organischen Chemie, volume XIV/1, Makromolekulare Stoffe, pages 192 to 208, Georg-Thieme-Verlag, Stuttgart, 1961.

Compounds which have also proven appropriate surface-active substances include those of the general formula I

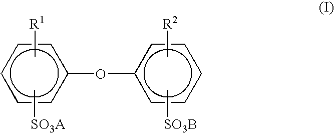

in which R¹ and R² can be C₄ to C₂₄ alkyl and one of the radicals R¹ or R² can also be hydrogen, and A and B can be alkali metal ions and/or ammonium ions. In the general formula I, R¹ and R² are preferably linear or branched alkyl radicals having 6 to 18 C atoms, having in particular 6, 12 and 16 C atoms or H atoms, with R′ and R² not both simultaneously being H atoms. A and B are preferably sodium, potassium or ammonium ions, sodium ions being particularly preferred. Particularly advantageous compounds I are those in which A and B are sodium ions, R¹ is a branched alkyl radical with 12 C atoms and R² is an H atom or R¹. Use is made frequently of technical mixtures containing a fraction of 50% to 90% by weight of the monoalkylated product, an example being Dowfax® 2A1 (brand of the Dow Chemical Company). The compounds I are general knowledge, from U.S. Pat. No. 4,269,749, for example, and are available commercially.

For the process of the invention it is preferred to use nonionic and/or anionic emulsifiers. It is also possible, however, to use cationic emulsifiers. Particular preference is given to using anionic emulsifiers such as alkylarylsulfonic acids, alkyl sulfates, sulfuric monoesters with ethoxylated alkanols and/or their corresponding alkali metal salts.

In general the amount of dispersant used is at least 0.1% and up to 15%, preferably at least 0.5% up to 5% and more preferably at least 0.5% up to 3% by weight, based in each case on the total monomer amount.

In accordance with the invention it is possible to include, if appropriate, a portion or the total amount of dispersant in the initial charge to the polymerization vessel. An alternative option, though, is to meter in the total amount or, if appropriate, remainder of dispersant together with the monomers, particularly in the form of an aqueous monomer emulsion, under polymerization conditions.

The initiation of the free-radically initiated aqueous emulsion polymerization is effected by means of a free-radical polymerization initiator (free-radical initiator). This initiator may in principle encompass not only peroxides but also azo compounds. Redox initiator systems are of course also suitable. Peroxides used may in principle be inorganic peroxides, such as hydrogen peroxide or peroxodisulfates, such as the mono- or di-alkali metal or ammonium salts of peroxodisulfuric acid, such as, for example, its mono- and di-sodium, -potassium or -ammonium salts or organic peroxides, such as alkyl hydroperoxides, examples being tert-butyl, p-menthyl or cumyl hydroperoxide, and also dialkyl or diaryl peroxides, such as di-tert-butyl peroxide or dicumyl peroxide. As an azo compound, use is made substantially of 2,2′-azobis-(isobutyronitrile), 2,2′-azobis(2,4-dimethylvaleronitrile) and 2,2′-azobis(amidinopropyl) dihydrochloride (AIBA, corresponding to V-50 from Wako Chemicals). Suitable oxidizing agents for redox initiator systems are essentially the abovementioned peroxides. As corresponding reducing agents it is possible to use compounds of sulfur having a low oxidation state, such as alkali metal sulfites, for example potassium and/or sodium sulfite, alkali metal hydrogen sulfites, for example, potassium and/or sodium hydrogen sulfite, alkali metabisulfites, for example potassium and/or sodium metabisulfite, formaldehyde sulfoxylates, for example potassium and/or sodium formaldehyde sulfoxylate, alkali metal salts, especially potassium and/or sodium salts, of aliphatic sulfinic acids, and alkali metal hydrogen sulfides, such as potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid and also reducing saccharides, such as sorbose, glucose, fructose and/or dihydroxyacetone. In general the amount of free-radical initiator used, based on the total monomer amount, is 0.01% to 5%, preferably 0.1% to 3%, and with particular preference 0.2% to 1.0%, by weight.

In accordance with the invention, it is possible to include if appropriate a portion or the total amount of free-radical initiator in the initial charge to the polymerization vessel. An alternative option is to meter in the total amount or, if appropriate, remainder of free-radical initiator to the polymerization vessel under polymerization conditions.

In accordance with the invention it is also possible to use further, optional auxiliaries familiar to the skilled worker, such as, for example, what are called thickeners, defoamers, neutralizing agents, preservatives, free-radical chain transfer compounds and/or complexing agents.

In order to tailor the rheology of the aqueous copolymer dispersions that are obtainable in accordance with the invention, in the course of preparation, handling, storage, and application, it is common to use what are called thickeners or rheological additives as a formulating ingredient. The skilled worker is aware of a large number of different thickeners, examples being organic thickeners, such as xanthan thickeners, guar thickeners (polysaccharides), carboxymethylcellulose, hydroxyethylcellulose, methyl-cellulose, hydroxypropylmethylcellulose, and ethylhydroxyethylcellulose (cellulose derivates), alkali-swellable dispersions (acrylate thickeners) or hydrophobically modified, polyether-based polyurethanes (polyurethane thickeners) or inorganic thickeners, such as bentonite, hectorite, smectite, attapulgite (Bentone) and also titanates or zirconates (metal organyls).

In order to prevent the formation of foam during preparation, handling, storage, and application of the aqueous copolymer dispersions that are obtainable in accordance with the invention, use is made of what are called defoamers. The defoamers are familiar to the skilled worker. They are, essentially, mineral oil defoamers and silicone oil defoamers. Defoamers, especially the highly active silicone-containing varieties, must generally be selected very carefully and metered very carefully, since they can lead to surface defects (craters, dimples, etc.) in the coating. It is important that, through addition of very finely divided hydrophobic particles, such as hydrophobic silica or wax particles, to the defoamer liquid, the defoamer effect can be increased further.

If necessary, acids or bases familiar to the skilled worker as neutralizing agents can be used to adjust the pH of the aqueous polymer dispersions that are obtainable in accordance with the invention.

In order to avoid infestation by microorganisms of the aqueous copolymer dispersions that are obtainable in accordance with the invention, in the course of preparation, handling, storage, and application, examples of such microorganisms being bacteria, molds, fungi or yeasts, it is common to use biocides or preservatives that are familiar to the skilled worker. Used particularly in this context are active-ingredient combinations of methyl- and chloroisothiazolinones, benzisothiazolinones, formaldehyde and formaldehyde donors.

In the process of the invention for preparing the aqueous copolymer dispersions it is optionally possible, in addition to the aforementioned components, to use free-radical chain transfer compounds as well, in order to reduce or control the molecular weight of the copolymers available through the polymerization. Compounds employed in this context are, essentially, aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide; organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methylbenzenethiol, and also all further sulfur compounds described in Polymer Handbook, 3^{rd} edition, 1989, J. Brandrup and E. H. Immergut, John Wiley & Sons, section II, pages 133 to 141; and also aliphatic and/or aromatic aldehydes, such as acetaldehyde, propionaldehyde and/or benzaldehyde; unsaturated fatty acids, such as oleic acid; dienes containing nonconjugated double bonds, such as divinylmethane or vinylcyclohexane; or hydrocarbons containing readily abstractable hydrogen atoms, such as toluene, for example. It is advantageous to use tert-dodecyl mercaptan, 2,4-diphenyl-4-methyl-1-pentene, and terpinolene (see, for example, DE-A 10046930 or DE-A 10148511).

The total amount of the further optional auxiliaries, based on the total monomer amount, is generally not more than 10%, not more than 5%, and often not more than 3% by weight.

In accordance with the invention it is possible to include, if appropriate, portions or total amounts of further optional auxiliaries in the initial charge to the polymerization vessel. It is also possible, however, to meter total amounts or any remainders of further optional auxiliaries in under polymerization conditions, if appropriate as a constituent of the monomer mixture and/or of the aqueous monomer emulsion comprising said mixture.

Optionally the free-radically initiated aqueous emulsion polymerization of the invention can also take place in the presence of a polymer seed, in the presence for example of 0.01 to 10%, frequently of 0.01% to 5%, and often of 0.04% to 3.5% by weight of a polymer seed, based in each case on the total monomer amount.

A polymer seed is used particularly when the particle size of the polymer particles to be prepared by means of free-radical aqueous emulsion polymerization is to be set in a controlled way (in this regard see, for example, U.S. Pat. No. 2,520,959 and U.S. Pat. No. 3,397,165).

Use is made in particular of polymer seed whose particles have a narrow size distribution and weight-average diameters D_{w} up to 300 nm, frequently at least 5 nm up to 200 nm, and often at least 80 nm up to 200 nm. Determination of the weight-average particle diameters is known to the skilled worker and is accomplished, for example, via the method of the analytical ultracentrifuge. By weight-average particle diameter in this specification is meant the weight-average D_{w50} value determined by the method of the analytical ultracentrifuge (cf. in this regard S. E. Harding et al., Analytical Ultracentrifugation in Biochemistry and Polymer Science, Royal Society of Chemistry, Cambridge, Great Britain 1992, chapter 10, Analysis of Polymer Dispersions with an Eight-Cell AUC Multiplexer: High Resolution Particle Size Distribution and Density Gradient Techniques, W. Mächtle, pages 147 to 175).

A particle size distribution is considered narrow for the purposes of this specification when the ratio of the weight-average particle diameter D_{w50} to the number-average particle diameter Dₙ₅₀ [D_{w50}/Dₙ₅₀] as determined by the method of the analytical ultracentrifuge is up to 2.0, preferably up to 1.5 and more preferably up to 1.2 or up to 1.1.

The polymer seed is typically used in the form of an aqueous polymer dispersion. The aforementioned quantities refer to the polymer solids fraction of the aqueous polymer seed dispersion; they are therefore specified as parts by weight of polymer seed solids, based on the total monomer amount.

Where a polymer seed is used it is advantageous to employ an exogenous polymer seed. Unlike an in situ polymer seed, which is prepared in the reaction vessel before the actual emulsion polymerization is commenced, and which has the same monomeric composition as the polymer prepared by the subsequent free-radically initiated aqueous emulsion polymerization, an exogenous polymer seed is a polymer seed which has been prepared in a separate reaction step and whose monomeric composition differs from that of the polymer prepared by the free-radically initiated aqueous emulsion polymerization, although this means nothing more than that different monomers, or monomer mixtures with a different composition, are used for preparing the exogenous polymer seed and for preparing the aqueous polymer dispersion. The preparation of an exogenous polymer seed is familiar to the skilled worker and is typically accomplished by the introduction and initial charge to a reaction vessel of a relatively small amount of monomers and also a relatively large amount of emulsifiers, and by the addition at reaction temperature of a sufficient amount of polymerization initiator.

It is preferred in accordance with the invention to use an exogenous polymer seed having a glass transition temperature of at least 50° C., frequently at least 60° C. or at least 70° C. and often at least 80° C. or at least 90° C. A polystyrene or polymethyl methacrylate polymer seed is particularly preferred.

In accordance with the invention it is possible to include if appropriate a portion or the total amount of exogenous polymer seed as a further optional auxiliary in the initial charge to the polymerization vessel. It is also possible, however, to meter in the total amount or any remainders of exogenous polymer seed under polymerization conditions.

By polymerization conditions are meant those temperatures and pressures at which the free-radically initiated aqueous emulsion polymerization proceeds at a sufficient polymerization rate. This is dependent in particular, however, on the free-radical initiator used. Advantageously, the nature and amount of the free-radical initiator, the polymerization temperature and the polymerization pressure are selected such that the free-radical initiator has a half life of up to 3 hours, with particular advantage of up to 1 hour and with very particular advantage of up to 30 minutes.

Depending on the free-radical initiator chosen a suitable reaction temperature for the free-radical aqueous emulsion polymerization of the invention is the entire range from 0 to 170° C. It is usual to employ temperatures here of 50 to 150° C., in particular 60 to 130° C. and advantageously 70 to 120° C. The free-radical aqueous emulsion polymerization of the invention can be carried out under a pressure of less than, equal to or greater than 1 atm, so that the polymerization temperature may exceed 100° C. and can be up to 170° C. In the presence of volatile monomers, such as ethylene, butadiene or vinyl chloride for example, it is preferred to carry out polymerization under elevated pressure. In that case the pressure may adopt 1.2, 1.5, 2, 5, 10, 15 bar (absolute) or even higher values. Where emulsion polymerizations are carried out under sub-atmospheric pressure, pressures of 950 mbar are set, frequently 900 mbar and often 850 mbar (absolute). With advantage the free-radical aqueous emulsion polymerization of the invention is carried out at elevated pressure under an inert gas atmosphere, such as under nitrogen or argon, for example.

In general the process of the invention takes place by the initial charging to the polymerization vessel at 20 to 25° C. (room temperature) under an inert gas atmosphere of a portion of the deionized water, of the dispersant and, if appropriate, a portion of the monomers and the free-radical initiator, followed by the heating of the initial charge mixture to the appropriate polymerization temperature, with stirring, and subsequently by the metered addition of the remaining amounts of deionized water and dispersing assistant and also of the total amounts or any remainders of monomers and also free-radical initiator. The metering of the monomers, of the free-radical initiator and of the other components may take place discontinuously in a plurality of portions, and also continuously, with constant or varying flow rates.

Typically a polymerization is implemented such that the monomers are metered at a uniform rate, throughout the metering time, into an initial charge, which in turn may comprise monomer; in other words, throughout the metering period, there is a linear relationship between the fraction of the monomer metered into the reaction mixture as a proportion of the total amount of the monomers and the instantaneous fraction of the metering time that has elapsed as a proportion of the metering period. If, for example, 100 g of a monomer or monomer mixture are polymerized over a metering period of one hour, this means that, after 15 minutes, 25 g have been metered into the polymerizing reaction mixture, 50 g after 30 minutes, and about 84 g after 50 minutes.

A feature of the present invention is that, in the context of the metering at least of the monomer (C), less than half the total amount of the monomer (C) is metered into the reaction mixture in the first half of the metering period, preferably not more than 45% by weight of monomer (C), more preferably not more than 40%, and very preferably not more than 35% by weight.

Formulated conversely, this means that more than half of the total amount of the monomer (C) is metered in in the second half of the metering period, preferably more than 55% by weight of the monomer (C), more preferably more than 60%, and very preferably more than 65% by weight.

It may be preferred, optionally, not to meter in any more monomer (C) at the end of the metering period, for example, in the last 5% of the metering period, and preferably in the last 10%.

In one preferred embodiment the monomers are metered in the form of two or more, preferably two, monomer emulsions, the first monomer emulsion (monomer emulsion 1) comprising at 60% by weight of the total monomer amount, but not more than 40% by weight of the total amount of the monomers (C), while the second monomer emulsion (monomer emulsion 2) comprises not more than 40% by weight of the total monomer amount, but at least 60% by weight of the total amount of the monomers (C). In this case the process of the invention takes place by the supplying first of monomer emulsion 1 and subsequently of monomer emulsion 2 to the polymerization vessel under polymerization conditions. In accordance with the invention it is possible in this case for a portion, if appropriate, of the monomer emulsion 1 to be included in the initial charge to the polymerization vessel and for the total amount or any remainder of the monomer emulsion 1 to be metered into the polymerization vessel under polymerization conditions discontinuously in two or more portions or continuously with constant or varying flow rates. Subsequent to this, the monomer emulsion 2 is metered into the polymerization vessel under polymerization conditions discontinuously in two or more portions or continuously with constant or varying flow rates.

A further preferred embodiment is to combine the monomers (A) and (B), and also the optional monomers (D) and (E), in the monomer emulsion 1, so that the monomer emulsion 2 completely comprises the monomer (C).

According to these embodiments, the monomer emulsion 2 can be metered differently over at least two, two to four for example, preferably two to three sections of the metering period. In that case it may be preferable not to meter any monomer (C) into the reaction mixture during a section of the metering period.

Preferably the monomer (C) is metered with the desired metering rate and metering volume into a preferably constant stream of the other monomers and is mixed with the remaining monomer stream shortly prior to the addition to the reaction mixture, by means of a static or, preferably, a dynamic mixer, such as a mixing pump, for example.

Without wishing to be tied to any one theory it is thought that the inventive addition of the hydrophilic monomer (C) into the reaction mixture, comprising hydrophobic monomers, generates relatively hydrophilic domains within a hydrophobic matrix, with the consequence that the increased hydrophilicity of the monomer (C) acts particularly at the surface of the polymer particles.

The choice of reaction conditions and the reaction regime are advantageously such that, after the free-radical polymerization reaction has been initiated, the monomers and the free-radical initiator are supplied to the polymerization mixture in the polymerization vessel in such a way that at any point in time the monomer conversion is at least 80%, advantageously at least 90%, and with particular advantage at least 95% by weight, based on the total amount of the monomers supplied to the polymerization mixture at that point in time, something which can be verified simply by means of reaction calorimetry measurements that are familiar to the skilled worker. In the process of the invention it is also possible in principle to use small amounts (up to 10% by weight, based on the total amount of water) of water-soluble organic solvents, such as, for example, methanol, ethanol, isopropanol, butanols, pentanols, but also acetone, etc. Preferably, however, the process of the invention is implemented in the absence of such solvents.

The number-average particle diameter (cumulant z-average) determined by way of quasielastic light scattering (ISO standard 13 321) of the aqueous copolymer dispersions obtained by the process of the invention is situated generally between 10 and 2000 nm, frequently between 20 and 300 nm, and often between 30 and 200 nm.

In the case of the aqueous copolymer dispersions obtained in accordance with the invention, it will be appreciated that it is possible for the residual levels of unreacted monomers and also of other low-boiling compounds to be lowered by means of chemical and/or physical methods that are familiar to the skilled worker [see, for example, EP-A 771328, DE-A 19624299, DE-A 19621027, DE-A 19741184, DE-A 19741187, DE-A 19805122, DE-A 19828183, DE-A 19839199, DE-A 19840586, and 19847115].

The aqueous polymer dispersions thus obtained preferably have a solids content of 35% to 65%, more preferably of 45% to 55% by weight.

The polymer dispersions are notable for a high stability, and there is virtually no coagulum formed.

The minimum film-forming temperature (MFT) of the polymer dispersions of the invention is advantageously less than 70° C.

The polymer dispersions can be used as binders for coating materials, such as for varnishes, protective coatings, traffic markings, decorative coatings, paints, coatings on textiles, leather or leather substitutes, for the purpose of improving the early water-spot resistance.

For the different utilities it is possible to add suitable auxiliaries, examples being flow control agents, thickeners, defoamers, fillers, pigments, pigment dispersing assistants, etc.

The coatings can be obtained by applying the coating materials to appropriate substrates, such as wood, concrete, metal, glass, plastic, ceramics, plasters, stone, asphalt, textiles, and coated, primed or weathered substrates, preferably to metal.

Application to the substrate may be made in a known way, as for example by spraying, troweling, knifecoating, brushing, rolling, roller coating or pouring. The coating thickness is generally in a range from about 3 to 1000 g/m² and preferably 10 to 200 g/m². The volatile constituents of the dispersions are subsequently removed. This operation may if desired be repeated one or more times.

For removing the water comprised in the dispersion, application to the substrate is followed by drying, in a tunnel oven for example, or by flashing off. Drying may also take place by means of NIR radiation, NIR radiation here denoting electromagnetic radiation in the wavelength range from 760 nm to 2.5 μm, preferably from 900 to 1500 nm. Drying may take place at a temperature from ambient temperature up to 100° C. over a period from a few minutes up to several days.

The coatings obtained generally feature a uniform surface, and in particular a surface free from blisters.

In one particular embodiment, the polymer dispersion of the invention is particularly suitable as a binder for anticorrosion coating materials and as a binder for paints. The polymer dispersions prepared in accordance with the invention are suitable, further-more, as primers for anticorrosion coating materials.

Besides the polymer dispersion, the anticorrosion coating materials may further comprise corrosion control agents, such as corrosion inhibitors or active anticorrosion pigments, an example being zinc phosphate.

Even without further corrosion control agents, the polymer dispersion of the invention has a good corrosion control effect in any case.

Using the polymer dispersions, the surfaces of iron, steel, Zn, Zn alloys, Al or Al alloys, as substrates, are treated for corrosion control. The surfaces may be uncoated, may be covered with zinc, aluminum or alloys thereof, may be hot-dip galvanized, electrogalvanized, sherardized or precoated with primers.

Paints, also referred to as emulsion paints, are one of the major product groups in the paints and coatings industry (see Ullmanns Enzyklopädie der technischen Chemie, 4th ed., volume 15, Verlag Chemie, Weinheim 1978, p. 665). Emulsion paints generally comprise a film-forming polymer as binder and as coloring constituent at least one inorganic pigment, and also inorganic fillers and assistants, such as defoamers, thickeners, wetting agents, and, if appropriate, film-forming assistants.

A further important property of the polymer dispersions is the effective blocking resistance of the coatings, by which is meant a minimal degree of sticking of the paint film to itself under pressure load and under elevated temperature (effective blocking resistance).

The paints (emulsion paints) of the invention comprise pigments and fillers preferably in amounts such that the pigment volume concentration (PVC) is 15% to 85% and more preferably 25% to 55%.

Typical pigments are, for example, titanium dioxide, preferably in the rutile form, barium sulfate, zinc oxide, zinc sulfide, basic lead carbonate, antimony trioxide, and lithopones (zinc sulfide+barium sulfate). The emulsion paints may, however, also comprise colored pigments, examples being iron oxides, carbon black, graphite, luminescent pigments, zinc yellow, zinc green, ultramarine, manganese black, antimony black, manganese violet, Paris blue or Schweinfurt green. Besides the inorganic pigments the emulsion paints of the invention may also comprise organic color pigments, examples being sepia, gamboge, Cassel brown, toluidine red, para red, Hansa yellow, indigo, azo dyes, anthraquinonoid and indigoid dyes, and also dioxazine, quinacridone, phthalocyanine, isoindolinone, and metal complex pigments.

Suitable fillers comprise aluminosilicates, such as feldspars, silicates, such as kaolin, talc, mica, magnesite, alkaline earth metal carbonates, such as calcium carbonate, in the form for example of calcite or chalk, magnesium carbonate, dolomite, alkaline earth metal sulfates, such as calcium sulfate, silicon dioxide, etc. The fillers can be used as individual components. In actual practice, however, filler mixtures have proven particularly appropriate, examples being calcium carbonate/kaolin and calcium carbonate/talc.

In order to increase the hiding power and to save on the use of white pigments it is common to use finely divided fillers, examples being finely divided calcium carbonate or mixtures of different calcium carbonates with different particle sizes. To adjust the hiding power, the hue, and the depth of color, it is preferred to use blends of color pigments and fillers.

The paint and anticorrosion coatings produced using the emulsion paints of the invention are notable for a high level of water resistance. The targeted higher hydrophobicity is manifested, for example, in reduced water absorption.

### EXAMPLES

### Preparation of the Copolymer Dispersions

### Comparative Dispersion CD

A 6 l pressure-rated reactor equipped with an MIG stirrer and 4 metering devices was charged at room temperature and under a nitrogen atmosphere with 490 g of deionized water, 157 g of 7% strength by weight aqueous itaconic acid, and 73 g of a 33% by weight polystyrene seed (particle size 30 nm, with 16 parts by weight of Disponil®LDPS 20 emulsifier) and also with 5% by weight each of feeds 1A, 1B, and 2. The contents of the reactor were then heated to 90° C. with stirring (180 rpm), and, when 85° C. were reached, 57 g of 3.5% strength by weight aqueous sodium persulfate were added. After 10 minutes, beginning simultaneously, the entirety of feed 1A and feed 2, over the course of 270 minutes, and feed 3, over the course of 300 minutes, were metered in continuously at constant volume flow rates. Again simultaneously, feed 2 was metered over the course of 270 minutes continuously and with constant volume flow rates. Throughout the metering time the volume flow rates of feed 1A, feed 1B, and feed 2 were homogenized by means of a mechanical stirrer (blade stirrer, 500 rpm) shortly prior to their entry into the reactor. The contents of the reactor were subsequently left to afterreact at 90° C. for 1 hour more. Thereafter the contents of the reactor were cooled to room temperature and the pressure vessel was let down to atmospheric pressure. The coagulum formed was separated from the dispersion by filtration on a sieve (mesh size 100 micrometers). Thereafter the pH was adjusted to 7.5 using 25% strength by weight aqueous ammonia.

Feed 1A
homogeneous mixture of

| | |
|---|---|
| 700 g | deionized water |
| 63 g | Disponil ® FES 27 from Cognis (28% strength by weight) |
| 66 g | Lutensol ® AT 18 from BASF (20% strength by weight) |
| 314 g | 7% strength by weight aqueous itaconic acid |

Feed 1B

| | |
|---|---|
| 22 g | 50% strength by weight aqueous acrylamide |

Feed 2
homogenous mixture of

| | |
|---|---|
| 1408 g | styrene |
| 31 g | tert-dodecyl mercaptan |
| 748 g | butadiene |

Feed 3

| | |
|---|---|
| 258 g | 3.5% strength by weight aqueous sodium persulfate |

The aqueous copolymer dispersion CD obtained had a solids content of 48.4% by weight, based on the total weight of the aqueous dispersion. The glass transition temperature was measured at 14.3° C. and the particle size at 143 nm. The water absorption figures for the polymer films are given in table 1.

Copolymer Dispersion D1

A 6 l pressure-rated reactor equipped with an MIG stirrer and 4 metering devices was charged at room temperature and under a nitrogen atmosphere with 490 g of deionized water, 157 g of 7% strength by weight aqueous itaconic acid, and 73 g of a 33% by weight polystyrene seed (particle size 30 nm, with 16 parts by weight of Disponil® LDPS 20 emulsifier) and also with 5% by weight each of feeds 1A, 1B, and 2. The contents of the reactor were then heated to 90° C. with stirring (180 rpm), and, when 85° C. were reached, 57 g of 3.5% strength by weight aqueous sodium persulfate were added. After 10 minutes, beginning simultaneously, the entirety of feed 1A and feed 2, over the course of 270 minutes, and feed 3, over the course of 300 minutes, were metered in continuously at constant volume flow rates. Again simultaneously, feed 1B was commenced, with 40% of the amount of this feed being metered in within the first 210 minutes and 60% of the amount of this feed being metered in over the course of the subsequent 60 minutes. Throughout the metering time the volume flow rates of feed 1A, feed 1B, and feed 2 were homogenized by means of a mechanical stirrer (blade stirrer, 500 rpm) shortly prior to their entry into the reactor. The contents of the reactor were subsequently left to afterreact at 90° C. for 1 hour more. Thereafter the contents of the reactor were cooled to room temperature and the pressure vessel was let down to atmospheric pressure. The coagulum formed was separated from the dispersion by filtration on a sieve (mesh size 100 micrometers). Thereafter the pH was adjusted to 7.5 using 25% strength by weight aqueous ammonia.

Feed 1A
homogeneous mixture of

| | |
|---|---|
| 700 g | deionized water |
| 63 g | Disponil ® FES 27 from Cognis (28% strength by weight) |
| 66 g | Lutensol ® AT 18 from BASF (20% strength by weight) |
| 314 g | 7% strength by weight aqueous itaconic acid |

Feed 1B

| | |
|---|---|
| 22 g | 50% strength by weight aqueous acrylamide |

Feed 2
homogenous mixture of

| | |
|---|---|
| 1408 g | styrene |
| 31 g | tert-dodecyl mercaptan |
| 748 g | butadiene |

Feed 3

| | |
|---|---|
| 258 g | 3.5% strength by weight aqueous sodium persulfate |

The aqueous copolymer dispersion obtained had a solids content of 50.7% by weight, based on the total weight of the aqueous dispersion. The glass transition temperature was measured at 14.8° C. and the particle size at 141 nm. The water absorption figures for the polymer films are given in table 1.

Copolymer Dispersion D2

A 6 l pressure-rated reactor equipped with an MIG stirrer and 4 metering devices was charged at room temperature and under a nitrogen atmosphere with 490 g of deionized water, 157 g of 7% strength by weight aqueous itaconic acid, and 73 g of a 33% by weight polystyrene seed (particle size 30 nm, with 16 parts by weight of Disponil®LDPS 20 emulsifier) and also with 5% by weight each of feeds 1A, 1B, and 2. The contents of the reactor were then heated to 90° C. with stirring (180 rpm), and, when 85° C. were reached, 57 g of 3.5% strength by weight aqueous sodium persulfate were added. After 10 minutes, beginning simultaneously, the entirety of feed 1A and feed 2, over the course of 270 minutes, and feed 3, over the course of 300 minutes, were metered in continuously at constant volume flow rates. Again simultaneously, feed 1B was commenced, with 40% of the amount of this feed being metered in within the first 150 minutes, then 50% of the amount of this feed being metered in over the course of 60 minutes, and subsequently 10% of the amount of this feed being metered in over the course of 30 minutes. Throughout the metering time the volume flow rates of feed 1A, feed 1B, and feed 2 were homogenized by means of a mechanical stirrer (blade stirrer, 500 rpm) shortly prior to their entry into the reactor. The contents of the reactor were subsequently left to afterreact at 90° C. for 1 hour more. Thereafter the contents of the reactor were cooled to room temperature and the pressure vessel was let down to atmospheric pressure. The coagulum formed was separated from the dispersion by filtration on a sieve (mesh size 100 micrometers). Thereafter the pH was adjusted to 7.5 using 25% strength by weight aqueous ammonia.

Feed 1A
homogeneous mixture of

| | |
|---|---|
| 700 g | deionized water |
| 63 g | Disponil ® FES 27 from Cognis (28% strength by weight) |
| 66 g | Lutensol ® AT 18 from BASF (20% strength by weight) |
| 314 g | 7% strength by weight aqueous itaconic acid |

Feed 1B

| | |
|---|---|
| 22 g | 50% strength by weight aqueous acrylamide |

Feed 2
homogenous mixture of

| | |
|---|---|
| 1408 g | styrene |
| 31 g | tert-dodecyl mercaptan |
| 748 g | butadiene |

Feed 3

| | |
|---|---|
| 258 g | 3.5% strength by weight aqueous sodium persulfate |

The aqueous copolymer dispersion obtained had a solids content of 49.4% by weight, based on the total weight of the aqueous dispersion. The glass transition temperature was measured at 12.7° C. and the particle size at 143 nm. The water absorption figures for the polymer films are given in table 1.

The solids contents were determined, generally, by drying a defined amount of the respective aqueous copolymer dispersion (approximately 5 g) to constant weight at 140° C. in a drying cabinet. Two separate measurements were carried out in each case. The figures reported in the examples represent the average of these two measurement results.

The glass transition temperature was determined in accordance with DIN 53765 by means of a DSC820 instrument, series TA8000, from Mettler-Toledo Int. Inc.

The average particle diameters of the polymer particles were determined by dynamic light scattering on a 0.005% to 0.01% by weight aqueous polymer dispersion at 23° C. using an Autosizer® IIC from Malvern Instruments, England. The figure reported is the average diameter of the cumulant evaluation (cumulant z-average) of the measured autocorrelation function (ISO standard 13321).

The water absorption of the polymer films was determined in accordance with DIN EN ISO 62.

TABLE 1

| | Dispersion | | |
|---|---|---|---|
| | CD | D1 | D2 |
| Metering | linear | in stages | in stages |
| Solids content [%] | 48.4 | 50.7 | 49.4 |
| Glass transition temperature [° C.] | 14.3 | 14.1 | 12.7 |
| Particle size [nm] | 143 | 141 | 143 |
| Water absorption [%] | 2.61 | 1.57 | 1.03 |

1-13. (canceled)

14. A process for protecting metallic substrates against corrosion, comprising
I) preparing by emulsion polymerization a polymer comprising as synthesis components in copolymerized form
(A) at least one vinylaromatic compound,
(B) at least one compound having two conjugated ethylenically unsaturated double bonds,
(C) at least one ethylenically unsaturated compound selected from the group consisting of compounds having at least one amide function and hydroxyalkyl (meth)acrylates,
(D) optionally at least one compound, other than the compounds (A) and (C), having an ethylenically unsaturated double bond, and
(E) optionally at least one compound, other than compounds (B), having at least two ethylenically unsaturated double bonds,
at least a portion of the monomers being metered into the reaction mixture during the polymerization over a certain time period or metering period,
and less than half the total amount of the monomer (C) being metered into the reaction mixture in the first half of the metering period,
II) optionally mixing the resultant polymer with at least one auxiliary selected from the group consisting of flow control agents, thickeners, defoamers, fillers, pigments, pigment dispersing assistants, corrosion inhibitors, and active anti-corrosion pigments,
III) applying the coating material to the metallic substrate, and
IV) drying the coating at a temperature from ambient temperature up to 100° C. over a period from a few minutes up to several days.

15. The process according to claim 14, wherein monomer (A) is styrene.

16. The process according to claim 14, wherein monomer (B) is 1,3-butadiene.

17. The process according to claim 14, wherein monomer (C) is acrylamide.

18. The process according to claim 14, wherein monomer (C) is selected from the group consisting of N-vinylformamide, N-vinylacetamide, N-vinylpyrrolidone, and N-vinylcaprolactam.

19. The process according to claim 14, wherein monomer (C) is selected from the group consisting of 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 4-hydroxybutyl acrylate, and 4-hydroxybutyl methacrylate.

20. The process according to claim 14, wherein the composition of the emulsion polymer is as follows:
(A) 40% to 80% by weight,
(B) 20% to 60% by weight,
(C) 0.1% to 10% by weight,
(D) 0% to 30% by weight, and
(E) 0% to 5% by weight,
with the proviso that the sum is always 100% by weight.

21. The process according to claim 14, wherein not more than 45% by weight of the total amount of the monomer (C) is metered into the reaction mixture in the first half of the metering period.

22. The process according to claim 21, wherein monomer (C) is no longer metered in in the last 5% of the metering period.

23. The process according to claim 14, wherein the metallic substrate is selected from the group consisting of iron, steel, zinc, zinc alloys, aluminum, and aluminum alloys.

24. The process according to claim 23, wherein the surface of the metallic substrate is uncoated, covered with zinc, aluminum or alloys thereof, hot-dip galvanized, electrogalvanized, sherardized or precoated with primers.

25. An emulsion polymer for protecting metallic substrates against corrosion obtained by the process according to claim 14.
